(19) United States
(12) Patent Application Publication
(10) Pub. No.: US 2016/0000184 A1
(43) Pub. Date: Jan. 7, 2016

(54) Insole and Method of Fabricating

(71) Applicant: Jason Guadalajara, Covina, CA (US)

(72) Inventor: Jason Guadalajara, Covina, CA (US)

(21) Appl. No.: 14/325,353

(22) Filed: Jul. 7, 2014

(51) Int. Cl. A43B 13/38; B29C 44/56; A43B 7/18

(52) U.S. Cl. CPC A43B 13/386; A43B 7/18; B29C 44/5618; B29D 35/122

(57) ABSTRACT

A method and apparatus comprises activating a recurable resin by applying a heat source. A foam material is impregnated with the activated recurable resin. The impregnated foam material is dried to substantially harden the recurable resin. The dried impregnated foam material is inserted into a chamber. The chamber comprises a heat resistant material and a shape configured for application to a user's body part, wherein a subsequent application of a subsequent heat source to at least the chamber and an application of the chamber to the user's body part molds the impregnated foam material to the user's body part.

### CROSS- REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to insoles or inserts for shoes. More particularly, the invention relates to custom made insoles or inserts for shoes and a method of making them.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. Some conventional approaches attempt to custom form an insole inside a shoe, by using an expandable uncured resin such as a moisture cured polyurethane foam. While it is effective for making a custom mold, the custom mold could only be cured once.

By way of educational background, another aspect of the prior art generally use expandable uncured resins which need a catalyst to activate. The most common catalyst is moisture. Generally, practitioners are concerned about the risk of moisture easily invading the insole and activate the uncured resin during production or on the way to consumer. Most of the expandable resins are very sensitive and also have a short shelf life of three to twelve months. Therefore, it is unrealistic to bring this product to market and global distribution as it can take many months for production, logistics and finally shipping to retail stores or distributors and many more months until a customer purchases it. By the time the end customer attempts to mold the product, it is very like moisture has already set off the reaction. The expandable uncured resins also cannot be remolded if a customer makes a mistake. Expandable resins also contain Methyl di-p-phenylene isocyanate (MDI) which is known to cause severe allergic reactions to some people and are considered highly toxic and should not be given to consumers in uncured form.

A problem in the prior art method of making custom insoles is that it was only a one time cure after reacting with the curing agent. Once the insole is cured for the first time, it would not be able to be refitted or reshaped. The inability to remold the insoles when using a new pair of shoes or boots makes it uncomfortable in many situations and unusable in some shoes. If any mistakes are made during the curing process, the insoles are ruined.

Another problem in the prior art method of making custom insoles is that the curing agent would also spill out of the insole when injected or introduced, making the soles and shoes wet during the molding process and potentially exposing the skin to the curing agent and resin.

Some of the prior art custom insoles are heat moldable insoles being hollow under the arch, and they are easy to collapse with body weight, and thus not be able to support the feet as orthotics. Some of the prior art custom insoles use heat cured resin mixed with cork. When heated, the cork could be slightly molded. Generally, practitioners are concerned about the risk of the cork not expanding as resin, and thus it will not fit most people's arch height.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-D illustrate an exemplary method of recurable resin forming custom insoles in accordance with an embodiment of the present invention;

FIGS. 2A-C illustrate an exemplary method of customizing an insole in accordance with an embodiment of the present invention; and

FIG. 3 illustrates a flow chart of an exemplary method of customizing an insole in accordance with an embodiment of the present invention.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

The present embodiment uses a stable heat activated resin which is recurable by heat. Instead of expanding to cure in a specific shape, the resin locks a foam into a specific shape until the resin is reactivated at which point it will release the hold on the foam which can return to its original shape to be molded again. The resin becomes hard in its dormant state which provides firm and stable custom support that foam alone cannot achieve.

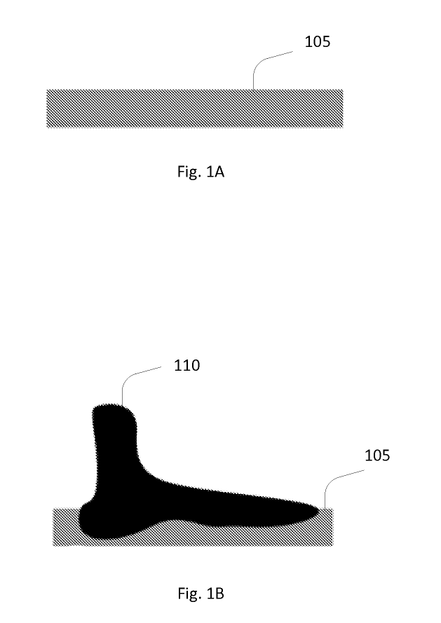

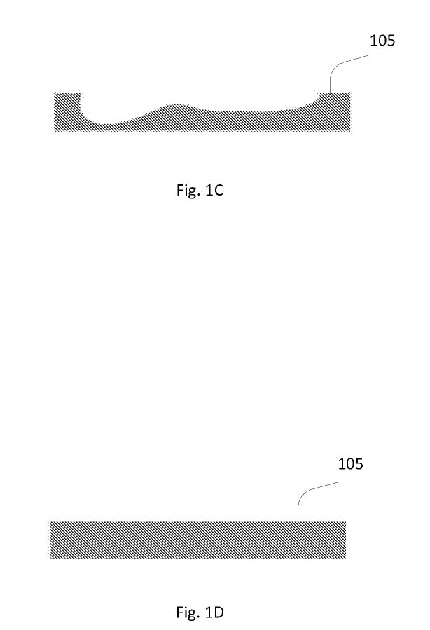

FIGS. 1A-D illustrates an exemplary method of a recurable resin forming custom insoles in accordance with an embodiment of the present invention. An example of a foam impregnated with the recurable resin 105 is illustrated by way of example in FIG. 1A. While the foam is in the soft state, the resin is activated, and a pressure is applied by an object, such as a foot 110 to mold the shape, by way of example in FIG. 1B. While the foam is in the hard state, the object to be molded, such as the foot 110, is removed when resin cures, leaving the firm custom mold 105, by way of example in FIG. 1C. If remolded is needed, reheat the resin and foam to a curing point, the impregnated foam 105 will rise again to the original shape due to the nature of open cell foam and can be recured and remolded for any foot again, by way of example in FIG. 1D. In many embodiments, the impregnated foam may be heated to the curing point with various typed of heating devices such as, but not limited to, an oven, toaster oven, etc. In some embodiments, different resins may be designed to activate at different temperatures.

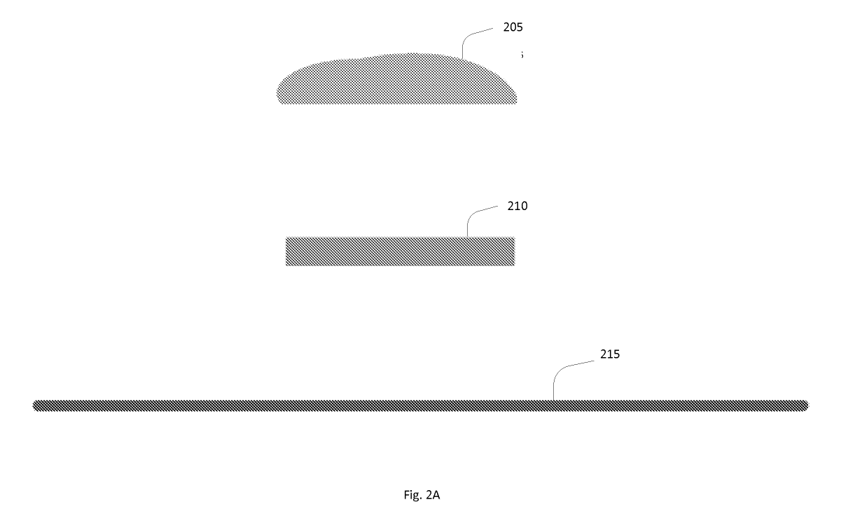

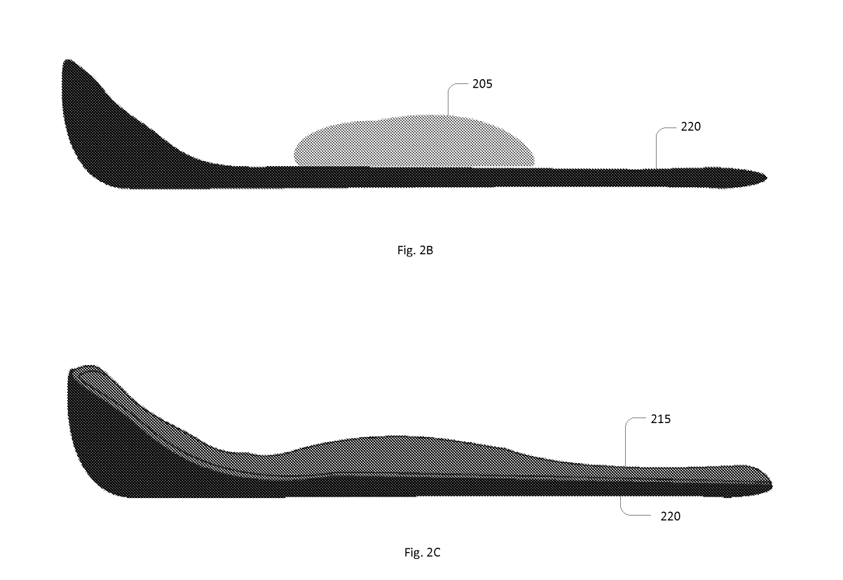

FIGS. 2A-C illustrates an exemplary method of customizing an insole in accordance with an embodiment of the present invention. FIG. 2A illustrates elements needed to customize an insole, including a heat resistant bag 205, an arch foam impregnated with heat curable resin 210, and a top layer 215. The heat resistant bag 205 can be a temperature resistant bag, such as, but not limited to, an aluminum vacuum sealed bag and a temperature resistant plastic bag, to act as a chamber if using a heat curable resin. The arch foam impregnated with heat curable resin 210 is formed by activating the recurable resin and saturating the open cell foam with it so the cells of the foam become filled with the resin. In alternate embodiments, a closed cell foam such as, but not limited to, Ethylene Vinyl Acetate (EVA) may be used without a bag. The top layer 215 can be a performance foam or any other cushion, such as, but not limited to, EVA, open cell polyurethane foam, closed cell poly urethane foam, leather or lamb skin, poly ethylene, or other types of foam suitable for insoles. Those skilled in the art, in light of the teachings of the present invention, will readily recognize a multiplicity of alternative and suitable means for the temperature resistant bag and top layer.

By way of an example in FIG. 2B, in order to avoid a mess or leakage of the resin during recurring, place the impregnated foam 210 in a heat resistant bag 205 and vacuum seal it, and then place it in a desired area of an insole of a bottom layer 220. After placing the top layer 215 on top of the bottom layer 220 and sealed foam 210, seal the insole, by way of example in FIG. 2C. At this stage, the insole with arch pad placed inside is ready to mold. In another embodiment, the heat resistant bag 205 is not used, and the impregnated foam 210 is encased in a closed cell foam instead of an open cell foam as mentioned above. In many practical applications, the bag does not have to be elastic, often it needs to just be loose enough to fit the full foam insert at its full height. In many case, the amount of foam applied will usually determine the max height of the arch and may, thus, be varied depending on factors such as, without limitation size of insole being made, or women's vs mens shoes. The exact value may be determined by an engineer in light of the teaching of the present invention, yet on average 7-8 mm high is suitable in many common applications. Then it may be molded to any suitable height and/or shape within practical limits. In some embodiments, an injection molded insole with closed cell or unbreathable skin may be used where resin may be injected into a chamber which is then permanently sealed. In some embodiments, a closed cell material constructed insole with an arch chamber may be used where resin may be injected or sealed into the sealed arch chamber.

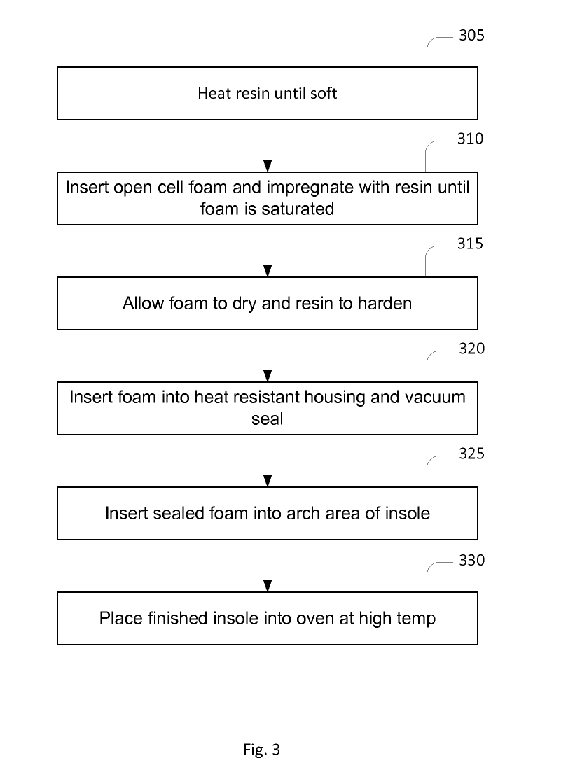

FIG. 3 illustrates a flow chart of an exemplary method of customizing an insole in accordance with an embodiment of the present invention. In a step 305, the resin is heated until sufficiently soft. After the resin becomes soft enough, at a Step 310, the open cell foam 210 is inserted and impregnated with the resin until the foam 210 is sufficiently saturated. After the foam 210 is sufficiently saturated with resin, at Step 315 allow time for the foam 210 to dry and the resin to harden. After the foam 210 is sufficiently dry as to no longer be in a liquid form and the resin is sufficiently hardened to no longer easily change shape by a weight of a body, the foam 210, saturated with resin, is inserted into a heat resistant housing 205 and vacuum sealed. After the foam 210 is inserted and sealed in the heat resistant housing 205, at Step 325 the sealed foam 210 is inserted into the arch area of the insole. After the sealed foam inserted into the insole, at Step 330, the finished insole is placed into an oven at high temperature, by way of example, not limitation, about 170° F. for 5-8 minutes or until arch is soft enough to be reshaped or deformed by the weight of the body. If the resin becomes hard before molding, heat the curable resins and warm the insole to the proper temperature until the impregnated arch foam becomes soft, in some way that it is optional. By way of an example, and not limitation, in order to warm the insole, place the insole into oven at high temperature, such as 170° F. for 5-8 minutes or until arch is soft. In the present non-limiting example, an air heater/blow dryer or conduction heating, if using a metal bag, may be used to warm the insole. When the resin and foam are both soft, the insole can be molded to any shape. To mold the insole to individually fit a user, place a foot on the insole and hold the shape in place with body weight or pressure. By way of an example, and not limitation, when the resin and form are both soft, the user places the insoles in a pair of shoes, the shape of the insole can be molded by the user wearing the shoes and walking for five minutes, in order to obtain a dynamic arch shape, in some way, that it is optional. By way of an example, and not limitation, when the resin and form are both soft, the user places the insole on the floor and stands on the insole for several minutes, in order to obtain a moderate arch shape, in some way, that it is optional. By way of an example, and not limitation, when the resin and form are both soft, the user sits down on a chair and puts pressure on insoles with user's feet, in order to obtain a more supportive arch shape, in some way, that it is optional. As it cools in temperature, the insole will recure and become hard again, maintaining the custom shape until the resin is reheated to its curing point again. Those skilled in the art, in light of the teachings of the present invention, will readily recognize a multiplicity of alternative and suitable means to heat and mold the insole. In many practical applications of the present embodiment, to fit multiple sizes, the finished insole may be trimmed to fit shoe, so long as the puncturing the chamber is avoided. For example, without limitation, if fitting to the arch only, it can be used over many sizes, yet if needed to mold to the entire foot, it would typically be made to each particular size.

An aspect of the present invention is to provide a method to custom mold the insoles so that the user can have a perfect custom fitting shoe in length, width and height even though every person has different shapes of feet. The resulting arch support is very firm in the same way as a custom orthotic from a lab without the expensive cost and time consuming process of having a custom orthotics made professionally. The insole is recustomizable and will expand again to full height once reheated.

Some alternative embodiments or the present invention may provide for custom molded shoe inserts for supporting a narrow foot in a wider shoe and/or supporting a shorter length foot in a longer shoe. In some alternate embodiment of the present invention, custom molded insets may provide for head support such as. But not limited to, in helmets, caps, masks, etc. In some other alternative embodiments, custom molded hand grips may be fitted to the user for gripping for example, but not limited to, tools, handle bars, steering wheels, computer pointing devices, etc. In some other embodiments, custom molded inserts may be fitted to the user for body protection devices for example, but not limited to, knee pads, elbow pads, etc. In some other embodiments, custom molded inserts may be fitted to the user for prosthetic devices. In some other embodiments, custom molded inserts may be fitted to the user for denture devices.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA Law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3rd parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing custom made insoles or inserts for shoes and a method of making them according to the present invention will be apparent to those skilled in the art. Various aspects of the invention have been described above by way of illustration, and the specific embodiments disclosed are not intended to limit the invention to the particular forms disclosed. The particular implementation of the custom made insoles or inserts for shoes and a method of making them may vary depending upon the particular context or application. By way of example, and not limitation, the custom made insoles or inserts for shoes and a method of making them described in the foregoing were principally directed to insoles or inserts implementations; however, similar techniques may instead be applied to side supports in shoes for people with narrow feet to be able to fit well into and use wide shoes, helmets to make them more form fitting to the head, or handle grips to take on one's hand shape for best gripping, etc., which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method comprising the steps of:
activating a recurable resin by applying a heat source;
impregnating a foam material with said activated recurable resin;
drying said impregnated foam material to substantially harden said recurable resin;
inserting said dried impregnated foam material into a chamber, said chamber comprising a heat resistant material and a shape configured for application to a user's body part, wherein a subsequent application of a subsequent heat source to at least said chamber and an application of said chamber to the user's body part molds said impregnated foam material to the user's body part.

2. The method as recited in claim 1, further comprising the step of placing said chamber in an arch area of a bottom layer of an insole.

3. The method as recited in claim 2, further comprising the step of placing a top layer on said chamber and said bottom layer to seal said insole.

4. The method as recited in claim 1, in which said chamber comprises a temperature resistant bag.

5. The method as recited in claim 4, in which said temperature resistant bag comprises an aluminum vacuum sealed bag.

6. The method as recited in claim 3, in which said top layer comprises an insole foam material.

7. The method as recited in claim 1, in which said foam material comprises and open cell structure.

8. The method as recited in claim 3, in which said sealed insole being subsequently heated is positionable in a shoe with the user inserting a foot into the shoe to mold the foam material.

9. The method as recited in claim 8, in which the user walks during the molding process.

10. The method as recited in claim 1, in which the user remolds said foam material by reheating said foam material.

11. The method as recited in claim 8, a body weight of the user is applied during the molding process.

12. An apparatus comprising:
a foam material impregnated with an activated recurable resin, said recurable resin being activated by a heat source;
a chamber being configured for enclosing said foam material with said foam material being dried to substantially harden said recurable resin, said chamber comprising a heat resistant material and a shape configured for application to a user's body part, wherein a subsequent application of a subsequent heat source to at least said chamber and an application of said chamber to the user's body part molds said impregnated foam material to the user's body part.

13. The apparatus as recited in claim 12, further comprising a bottom layer of an insole being configured for receiving said chamber in an arch area.

14. The apparatus as recited in claim 13, further comprising a top layer being configured for sealing said chamber inside said insole.

15. The apparatus as recited in claim 12, in which said chamber comprises a temperature resistant bag.

16. The apparatus as recited in claim 15, in which said temperature resistant bag comprises an aluminum vacuum sealed bag.

17. The apparatus as recited in claim 14, in which said top layer comprises an insole foam material.

18. The apparatus as recited in claim 12, in which said foam material comprises and open cell structure.

19. A method comprising the steps of:
activating a recurable resin by applying a heat source;
impregnating a foam material with said activated recurable resin, said foam material comprising an open cell structure;
drying said impregnated foam material to substantially harden said recurable resin;
inserting said dried impregnated foam material into an aluminum bag comprising a shape configured for application to a user's body part;
vacuum sealing said aluminum bag;
placing said vacuum sealed aluminum bag in an arch area of a bottom layer of an insole; and
placing a top layer comprising an insole foam material on said vacuum sealed aluminum bag and said bottom layer to seal said insole, wherein a subsequent application of a subsequent heat source to said sealed insole and placement of said heated sealed insole into a shoe with the user inserting a foot into the shoe with a body weight of the user being applied, molds said impregnated foam material to the user's foot, the user remolding said impregnated foam material by reheating said insole.

20. The method as recited in claim 19, in which the user walks during the molding process.
